(19) United States
(12) Patent Application Publication
(10) Pub. No.: US 2020/0291758 A1
(43) Pub. Date: Sep. 17, 2020

(54) Machine Learning Systems and Methods for Isolating Contribution of Geospatial Factors to a Response Variable

(71) Applicant: Wood Mackenzie, Inc., Houston, TX (US)

(72) Inventor: Preston Cody, Houston, TX (US)

(73) Assignee: Wood Mackenzie, Inc., Houston, TX (US)

(21) Appl. No.: 16/815,683

(22) Filed: Mar. 11, 2020

Related U.S. Application Data
(60) Provisional application No. 62/816,481, filed on Mar. 11, 2019.

(51) Int. Cl. E21B 43/16; E21B 49/00; G06N 20/00

(52) U.S. Cl. CPC E21B 43/16; G06N 20/00; E21B 49/003

(57) ABSTRACT

A system for modeling a contribution of at least one factor to performance of an oil or gas well is provided. The system assembles a dataset including a first response variable and at least one predictor of the oil or gas well and couples the assembled dataset and geospatial data based on a location of the oil or gas well. The system generates a first predictive model based on all or a subset of non-geospatial data and determines a second response variable based on a ratio of the first response variable to a first predictive value determined from the generated first predictive model. The system generates a second predictive model for the determined second response variable based on all or a subset of the geospatial data and determines a second predictive value for the determined second response variable based on the second predictive model. The second predictive value is a productivity multiplier indicative of performance of the oil or gas well.

### RELATED APPLICATIONS

The present application claims the priority of U.S. Provisional Application Ser. No. 62/816,481 filed on Mar. 11, 2019, the entire disclosure of which is expressly incorporated by reference.

### BACKGROUND

### Technical Field

The present disclosure relates generally to the field of computer-based machine learning systems. More specifically, the present disclosure relates to machine learning systems and methods for isolating contribution of geospatial factors to a response variable.

### Related Art

The field of machine learning has rapidly advanced in recent years. As a branch of artificial intelligence, machine learning involves systems that can learn from data, identify patterns, and make decisions with minimal human intervention. Machine learning has been applied to various fields of endeavor, including in the petroleum field.

Drilling is a process whereby a hole is bored to create a well for oil and natural gas production. Drilling wells is an expensive and time-consuming process. The process can be further complicated by geological factors and variables, such as formation depth and rock brittleness. Additionally, the performance (e.g., oil production) of each well can differ based on production/productivity factors, such as stock tank original oil-initially-in-place (“STOIIP”) and intensity (a measure of productivity related to proppant and fracking fluid). As such, it is desirable to predict certain features of a potential oil well, such as productivity, costs and safety characteristics, when grading a land parcel (acreage) for potential drilling sites. At present, machine learning systems cannot adequately learn (isolate) the contribution of geospatial factors to a response variable (such as oil well productivity, etc.), thereby reducing the effectiveness, speed, and accuracy of such computer-based tools in the petroleum industry. These and other needs are addressed by the machine learning systems and methods of the present disclosure.

### SUMMARY

The present disclosure relates to machine learning systems and methods for isolating contribution of geospatial factors to a response variable. Specifically, the system assembles a dataset comprising a response variable and predictors for each observation and joins the dataset to geospatial data based on a location of an observation. The system then develops or trains a first predictive model on all or a subset of non-geospatial data and divides the response variable actual value by a first predictive value from the first predictive model to generate a second response variable (e.g., a ratio of the actual value over the predicted value). Next, the system develops or trains a second predictive model for the second response variable based on all or a subset of the geospatial data. Lastly, the system calculates a second predicted value for the second response variable using the second predictive model. The value of the second predicted value (referred to herein as a “GeoFactor”) represents a continuous variable (e.g., a score) that acts as a multiplier for oil/gas well production.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating overall process steps carried out by the machine learning system of the present disclosure;

FIG. 2 is illustration showing oil production of Bakken Horizontal wells;

FIG. 3 is a graph showing a Bakken Well performance histogram;

FIG. 4A shows graphs illustrating averages of Bakken Well performance trends from a time period of 2012-2016;

FIG. 4B is a graph showing selected features/factors which drive well performance;

FIGS. 5A and 5B are graphs showing the Intensity of the Bakken Wells;

FIG. 6 is an illustration showing the system of the present disclosure generating a GeoFactor from subsurface characteristics and applying the GeoFactor to oil production data;

FIG. 7A is a graph showing the Intensity of the Bakken Wells as seen and discussed in FIG. 5A;

FIG. 7B is a graph showing a GeoFactor normalized Intensity of the Bakken Wells Intensity;

FIG. 8A is a graph showing well performance data graphed in relation to pounds of proppant per foot vs gallons of fracking fluid per foot;

FIG. 8B is a graph showing the well performance in FIG. 8A normalized by the GeoFactor, according the present disclosure;

FIG. 9 is a graph showing sensitivity on Intensity based on the data shown in FIG. 8B;

FIG. 10A is a graph showing the GeoFactor of a plurality of wells graphed in relation to rock brittleness vs formation depth, according to the present disclosure;

FIG. 10B is a graph showing the sensitivity of the GeoFactor of FIG. 10A, according to the present disclosure;

FIG. 11A is a graph showing the GeoFactor of a plurality of wells graphed in relation to Net-STOIIP vs formation depth, according to the present disclosure;

FIG. 11B is a graph showing the sensitivity of the GeoFactor of FIG. 11A, according to the present disclosure;

FIG. 12A is a graph of drivers for an F-Score, according to the present disclosure.

FIG. 12B is a list of other data elements that can enable the system of the present disclosure to differentiate well performance;

FIGS. 13A-14C are graphs showing the GeoFactor and the F-Score increasing the discriminatory power of the system of the present disclosure; and

FIG. 15 is a diagram illustrating sample hardware and software components capable of being used to implement the system of the present disclosure.

### DETAILED DESCRIPTION

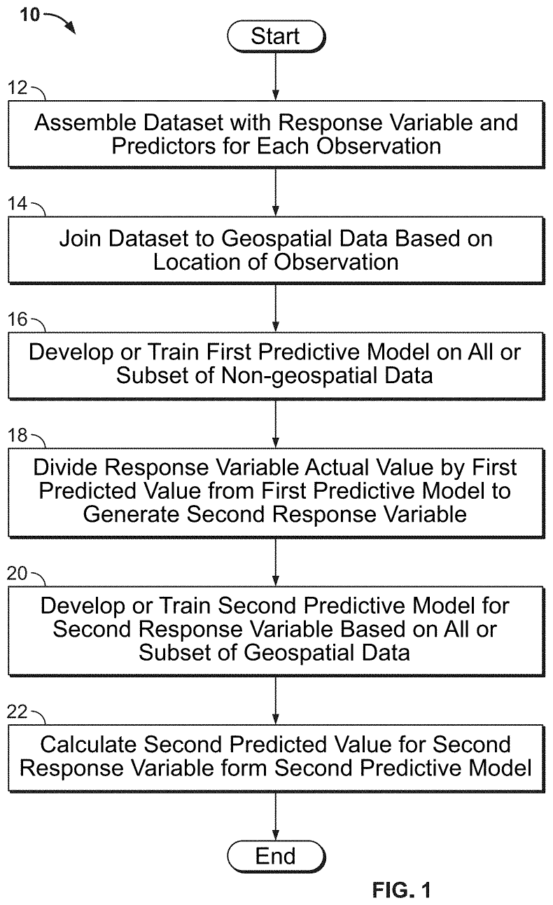

The present disclosure relates to machine learning systems and methods for isolating contribution of geospatial factors to a response variable, as described in detail below in connection with FIGS. 1-14.

FIG. 1 is a flowchart illustrating the overall process steps carried out by the system of the present disclosure, indicated generally at method 10. The objective of the system is to create models which isolate the contributions to oil/gas well performance that completion (e.g., code completion) engineering factors and geology. Method 10 of the system calculates a single coefficient from multiple factors. Advantageously, by isolating the aforementioned contributions, the models developed by the systems and methods of the present disclosure function with increased speed and accuracy, thereby improving the functionality of computer-based modeling systems.

In step 12, the system assembles a dataset comprising a response variable and predictors (also known as features) for each observation. A response variable (e.g., target variable) is a variable that is or should be the output. In a classifying process, the response variable can be a binary 0 or 1. In a regression process, the response variable can be a continuous variable. A predictor is input data or a variable that is mapped to the response variable through an empirical relationship. An observation is a set of predictors.

In step 14, the system joins the dataset to geospatial data based on a location of an observation. Geospatial data is derived from location specific data points through a variety of methods of interpolation and distance calculations from any given geospatial location to the locations of the original geospatial data. Typical geospatial predictors for this application include geological information, vertical depths below sea level of formations of interest, and characteristics of the lithology of said formations. In step 16, the system develops or trains a first predictive model on all or a subset of non-geospatial data. Non-geospatial data relates specifically to information about the observed data point (the well) that is not specific to its location. Typical non-geospatial data includes the length of the well, the engineering parameters of the well's drilling and completion, and non-physical characteristics such as what entity owns the well or when it was drilled. In step 18, the system divides the response variable actual value by a first predictive value from the first predictive model to generate a second response variable (e.g., a ratio of the actual value over the predicted value).

In step 20, the system develops or trains a second predictive model for the second response variable based on all or a subset of the geospatial data. In step 22, the system calculates a second predicted value for the second response variable using the second predictive model (referred to herein as a “GeoFactor”). The GeoFactor represents a continuous variable (e.g., a score) which acts as a multiplier for oil/gas well production. For example, a GeoFactor of 1.5 means that a well drilled in that acreage will produce 50% more than a similar well drilled in an average acreage (which would have a score of 1.0).

The system can use the GeoFactor as a coefficient to multiply the predicted values (e.g., the first predicted value) from models (e.g., the first predictive model) developed using features that are not part of the calculation for the GeoFactor. The system can also use the GeoFactor to normalize response variable data and develop new models or to retrain existing models on a response variable that has been divided by the GeoFactor. Additionally, the system can use the GeoFactor as develop or train models and update or retrain the GeoFactor(s) in an iterative manner. Such processing steps greatly improve the accuracy of predictions relating to oil well production (and other predictions) by the machine learning system. This system enables methods of visualizing and mapping how machine learning is detecting patterns between variables that are easier for human experts to communicate, audit, and understand. It enables faster processing time of subsequent processes and uses by converting multiple complex variable interactions into a single coefficient.

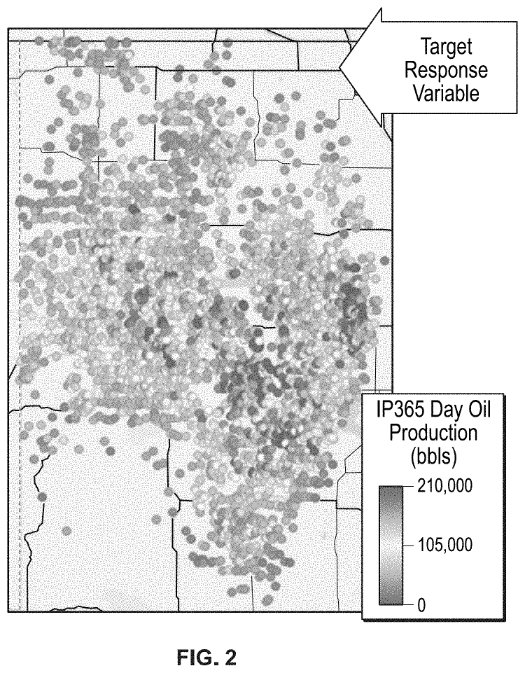

The properties and characteristics of wells will now be discussed, followed by the application of the GeoFactor onto data determined of the wells. FIG. 2 is an illustration showing oil production of Bakken Horizontal wells. Specifically, FIG. 2 shows approximately a dataset 4,100 Bakken Horizontal wells with sufficient data points on key completion parameters. The dataset expressed as IP365, which measures how many barrels (“bbls”) of oil a new well produces over an initial production rate of 365 days.

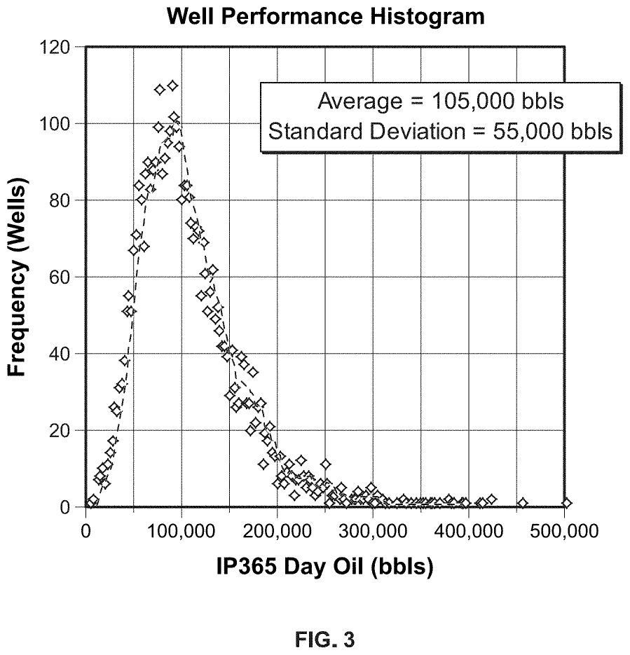

FIG. 3 is a graph showing a Bakken Well performance histogram. Specifically, FIG. 3 shows a distribution and variability of performance of the Bakken Wells. The x-axis represents a frequency of wells and the y-axis represents the IP365 (e.g., an initial production of barrels for a 365 day period).

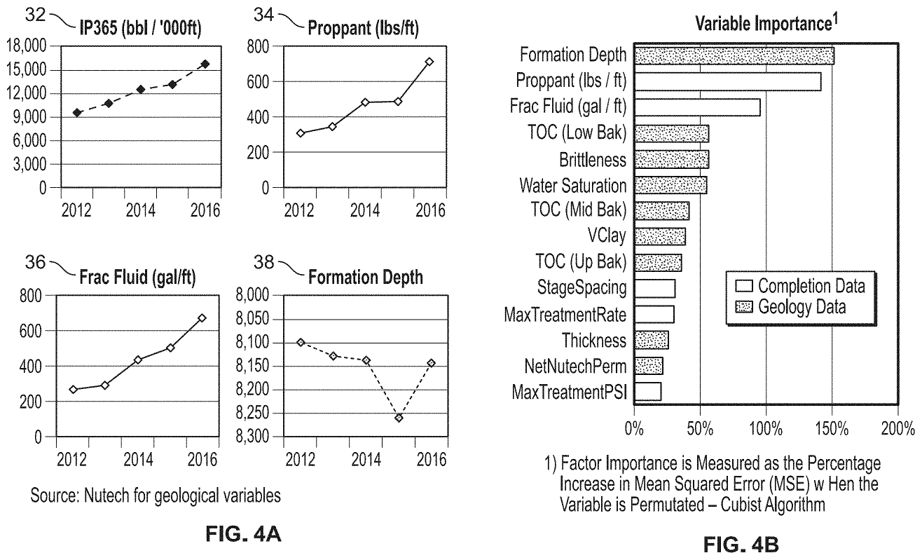

FIG. 4A shows four graphs 32, 34, 36, 38 illustrating averages of Bakken Well performance trends from a time period of 2012-2016. Specifically, graph 32 shows the amount of barrels produced during the time period, graph 34 shows the amount (in pounds) of proppant used per foot during the time period, graph 36 shows the amount (in gallons) of fracking fluid used per foot during the time period, and graph 38 show the formation depth (in feet) during the time period.

FIG. 4B is a graph showing selected features/factors which drive well performance. As seen, the selected features/factors include a formation depth, the amount of proppant used (in pounds per foot), the amount of fracking fluid used (in gallons per foot), the total organic carbon (“TOC”) or amount of concentration of organic material in source rocks as represented by the weight percent of organic carbon, the brittleness of the rocks, the amount of water saturation in the ground, the volume of clay (“VClay”), spacing between wells (“stage spacing), a maximum treatment rate, a thickness, a NetNutechPerm, and a maximum treatment PSI (pressure per square inch). It is noted some features/factors have a large impact on well performance (e.g., formation depth, amount of proppant used) while other have a smaller impact on well performance (NetNutechPerm, maximum treatment PSI).

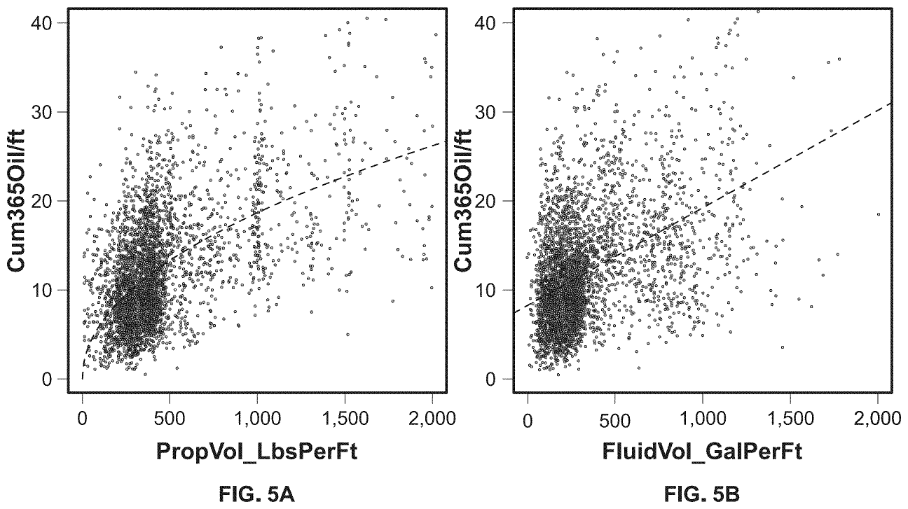

FIGS. 5A and 5B are graphs showing the Intensity of the Bakken Wells. Intensity is a measure of productivity related to proppant and fracking fluid. Specifically, Intensity is an estimate of the average amount of production (per lateral foot) expected from any given volume of proppant and fracking fluid. FIG. 5A shows measurements of proppant loading in pounds per foot on the x-axis, and the IP 365 (normalized by lateral length) per foot on the y-axis. As seen, there is a square root trend line due to diminishing returns to proppant loading. FIG. 5B shows measurements of fracking fluid volume in pounds per foot on the x-axis, and IP 365 (normalized by lateral length) per foot on the y-axis.

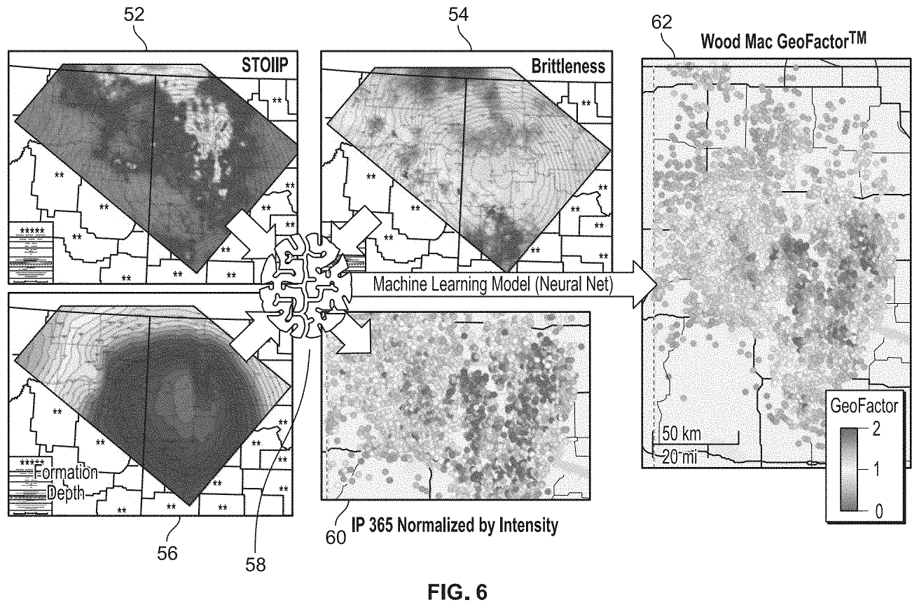

FIG. 6 is an illustration showing the system of the present disclosure generating a GeoFactor from subsurface characteristics, and applying the GeoFactor to oil production data. The GeoFactor acts as a multiplier to Intensity, and estimates how much geology will drive oil production above or below average productivity. Specifically, FIG. 6 shows STOIIP data 52, brittleness data 54, and formation depth data 56) fed into the system 58, then applied to oil production of Bakken Horizontal wells data discussed in FIG. 2, to generate a model 62 that estimates the GeoFactor (e.g., productivity multiplier) based on the subsurface characteristics (e.g., the STOIIP data 52, the brittleness data 54, and the formation data 56).

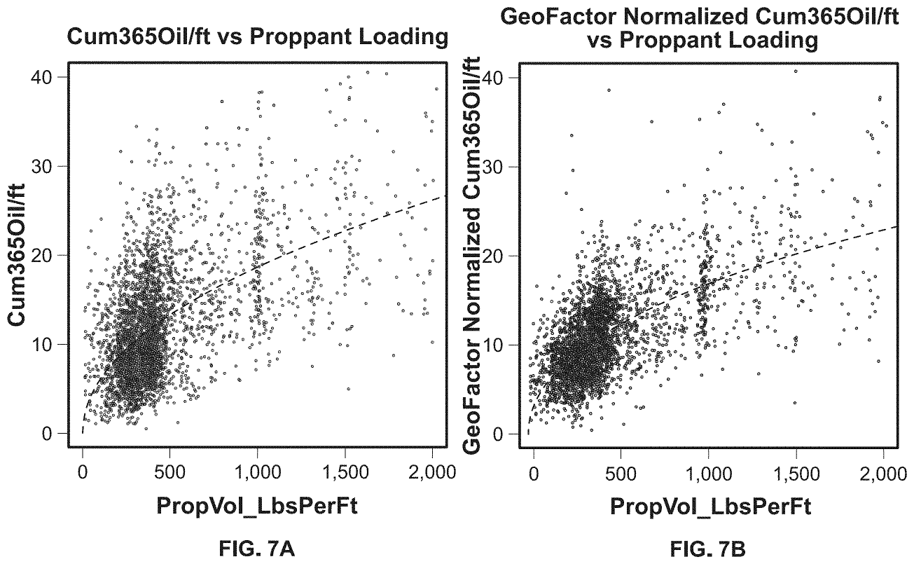

FIG. 7A is a graph showing the Intensity of the Bakken Wells as seen and discussed in FIG. 5A. FIG. 7B is a graph showing a GeoFactor normalized Intensity of the Bakken Wells Intensity. As seen, the graphs illustrate the GeoFactor normalized Intensity producing a better correlation between completion Intensity with production performance.

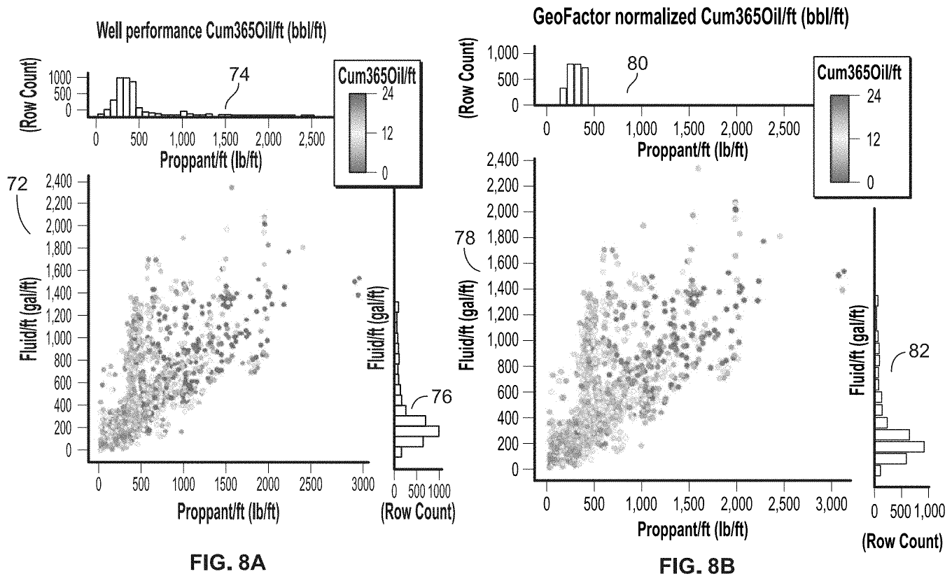

FIG. 8A is a graph 72 showing well performance data, in barrels per foot over a 365 days average, graphed in relation to pounds of proppant per foot (represented by the x-axis) vs gallons of fracking fluid per foot (represented by the y-axis). Bar graph 74 shows a pounds of proppant per foot row count and bar graph 76 shows a gallons of fracking fluid per foot row count of graph 72. FIG. 8B is a graph 78 showing the well performance in FIG. 8A normalized by the GeoFactor. Bar graph 80 shows a pounds of proppant per foot row count and bar graph 82 shows a gallons of fracking fluid per foot row count of graph 78. As seen, the GeoFactor reveals clearer trends between completion and well results.

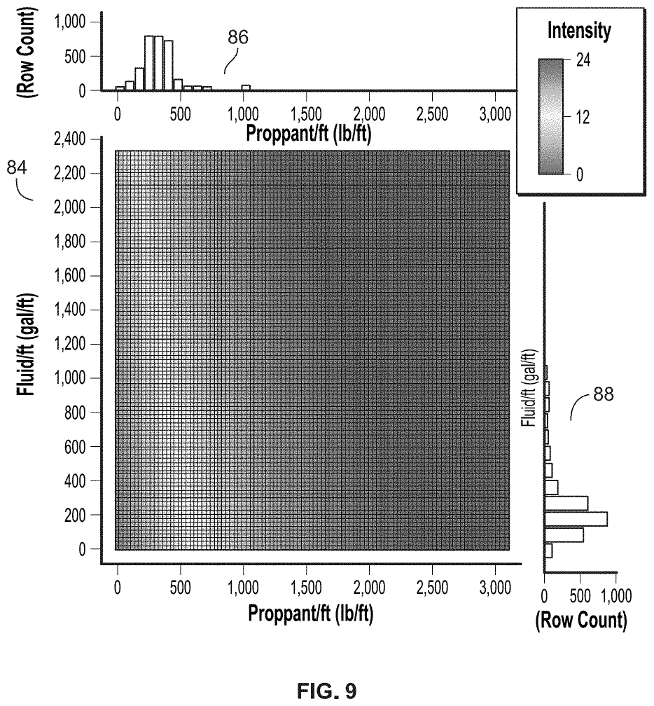

FIG. 9 shows a sensitivity on Intensity graph 84 based on the data shown in FIG. 8B. Intensity is calculated as 0.49 multiplied by the square root of proppant loading (lb/ft) plus 0.0025 multiplied by fluid intensity (gal/ft). Bar graph 86 shows a pounds of proppant per foot row count and bar graph 88 shows a gallons of fracking fluid per foot row count of graph 84.

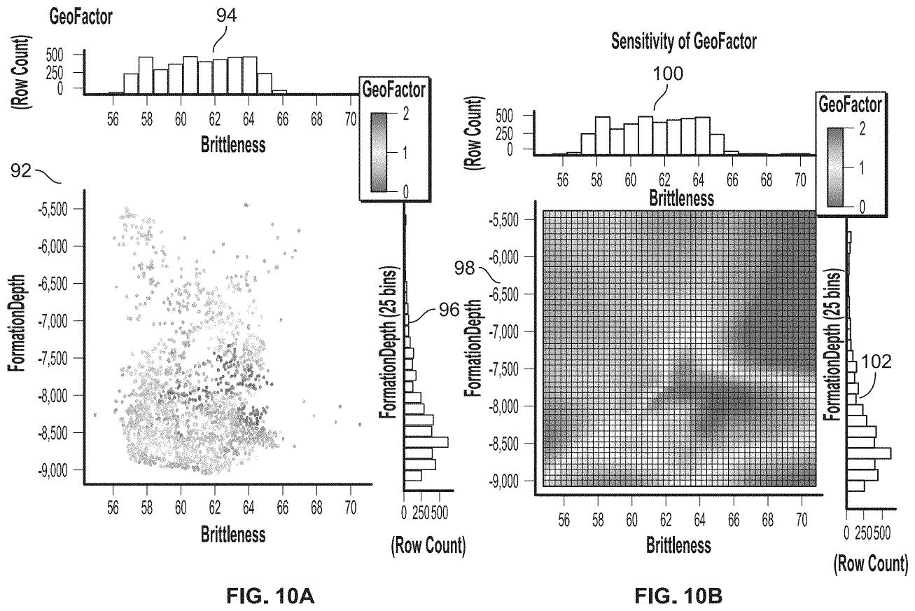

FIG. 10A is a graph 92 showing the GeoFactor of a plurality of wells graphed in relation to rock brittleness (represented by the x-axis) vs formation depth (represented by the y-axis). Bar graph 94 shows a brittleness row count and bar graph 96 shows a formation depth row count. FIG. 10B is a graph 98 showing the sensitivity of the GeoFactor of FIG. 10A. Bar graph 100 shows a pounds of proppant per foot row count and bar graph 102 shows a gallons of fracking fluid per foot row count of graph 98. It is noted that the system learns nonlinear relationships among geology variable and rock quality.

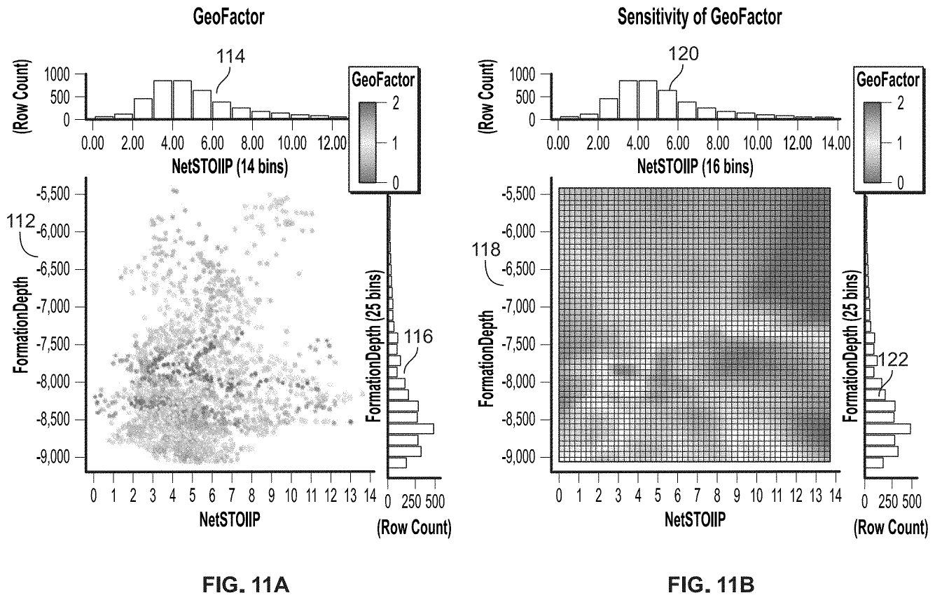

FIG. 11A is a graph 112 showing the GeoFactor of a plurality of wells graphed in relation to Net-STOIIP (represented by the x-axis) vs formation depth (represented by the y-axis). Bar graph 114 shows a Net-STOIIP row count and bar graph 116 shows a formation depth row count. FIG. 11B is a graph 118 showing the sensitivity of the GeoFactor of FIG. 11A. Bar graph 120 shows a Net-STOIIP row count and bar graph 122 shows a formation depth row count.

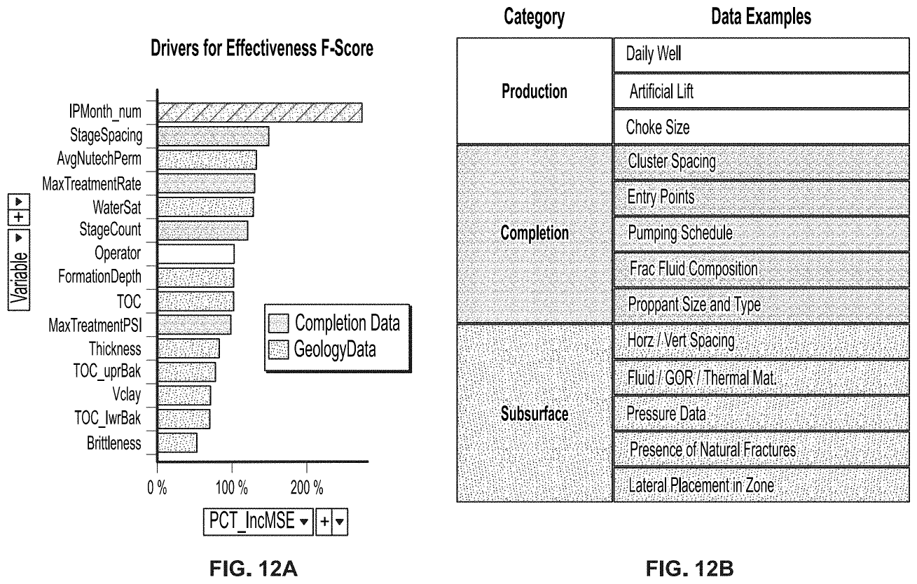

The system can use an F-score metric to capture remaining efficiency and effectiveness factors. Specifically, other information regarding the well and associated geology are processed into the F-Score to analyze remaining variability in well performance. FIG. 12A is a graph of drivers (variables) for the F-Score. The variables are split into four categories; 1) completion data, 2) geology data, 3) time, and 4) operator. The completion data can include stage spacing, maximum treatment rate, stage count, and maximum treatment PSI. The geology data can include an average Nutech Perm, a water saturation level, formation depth, TOC, thickness, VClay, and brittleness. FIG. 12B shows a list of other data elements that can enable the system to differentiate well performance. In the production category, the data examples include daily well, artificial lift, and choke size. In the completion category, the data examples include cluster spacing, entry points pumping schedule, fracking fluid composition, and proppant size and type. In the subsurface category, the data examples include horizontal and vertical spacing, fluid, gas to oil ratio (“GOR”), thermal material, pressure data, presence of natural fractures, and lateral placement in zone.

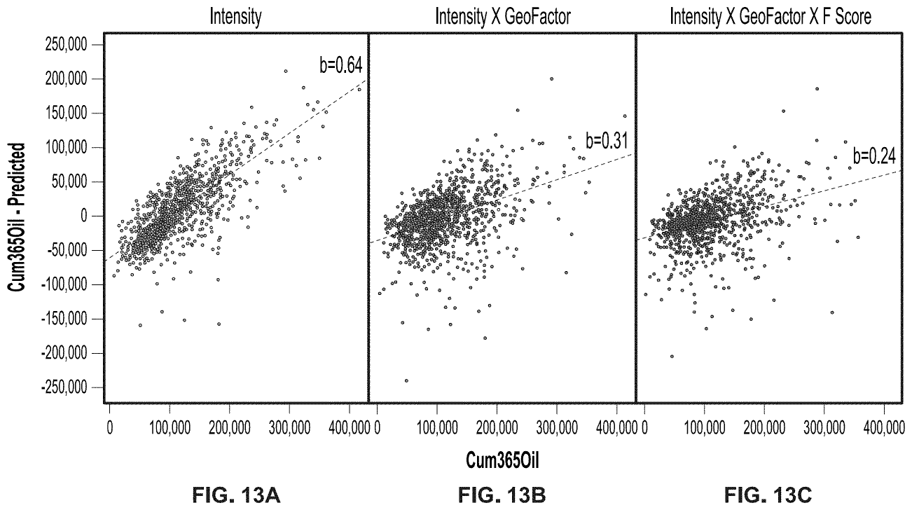

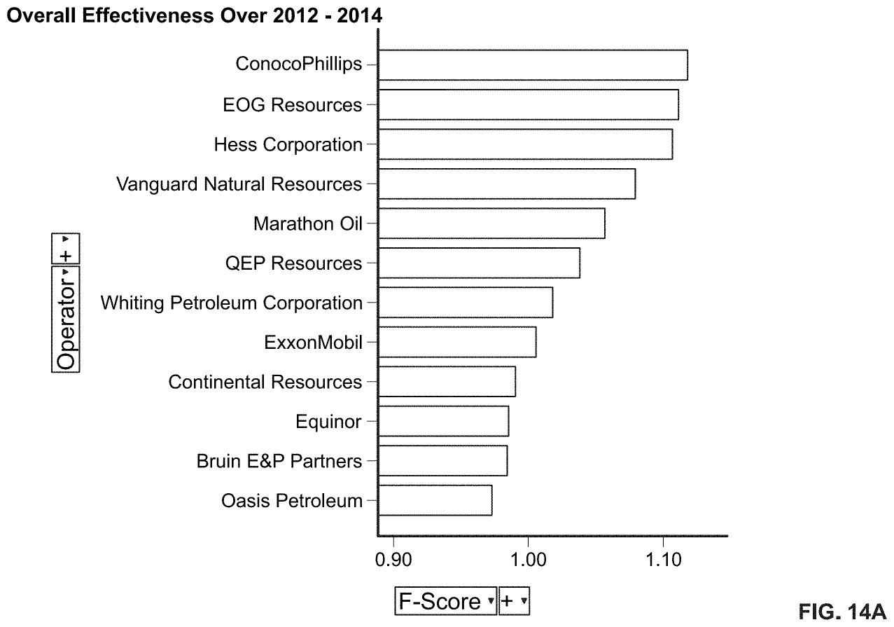

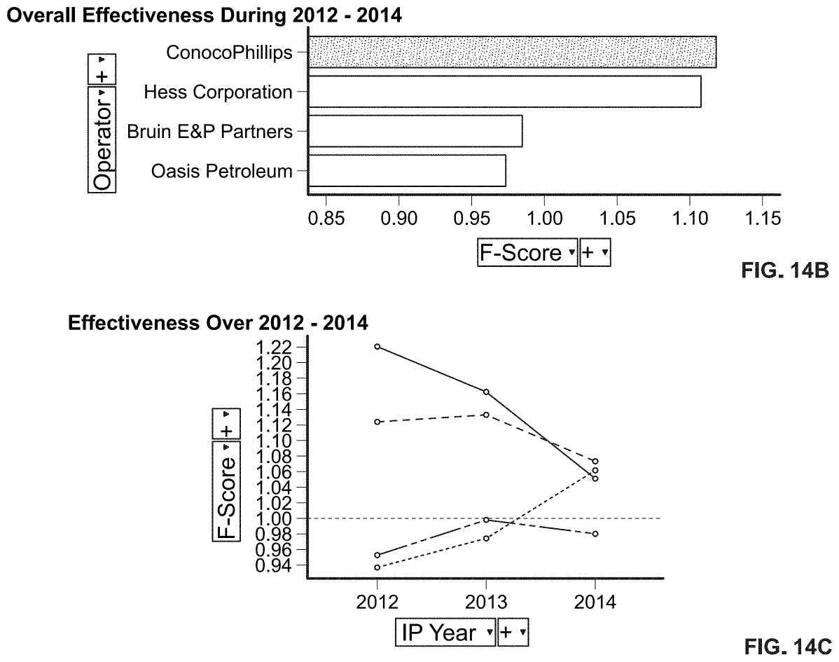

The FIGS. 13-14C graphs show the GeoFactor and the F-Score increasing the discriminatory power of the system. Specifically, FIG. 13A shows the Intensity, FIG. 13B shows the Intensity multiplied by the GeoFactor, and FIG. 13C shows the Intensity multiplied by the GeoFactor and the F-Score. As seen, Intensity explains 36% of over/under performance of wells, GeoFactor explains a further 33% of over/under performance of wells, and the F-Score explains an additional 7% of over/under performance of wells.

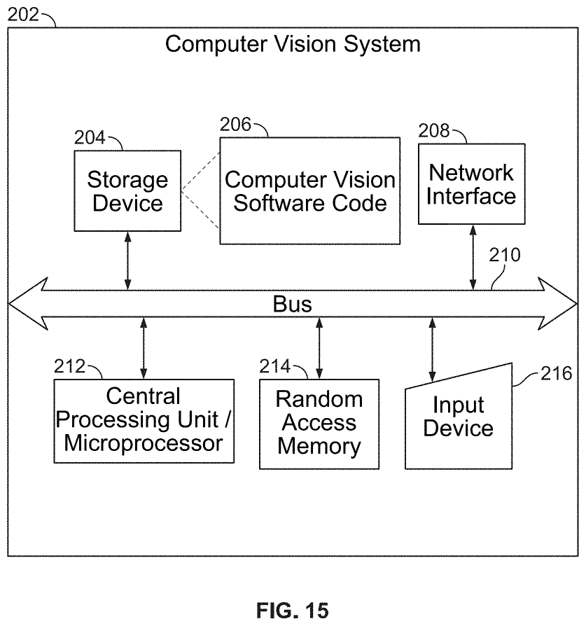

FIG. 15 is a diagram showing a hardware and software components of a computer system 202 on which the system of the present disclosure can be implemented. The computer system 202 can include a storage device 204, machine learning software code 206, a network interface 208, a communications bus 210, a central processing unit (CPU) (microprocessor) 212, a random access memory (RAM) 214, and one or more input devices 216, such as a keyboard, mouse, etc. The server 202 could also include a display (e.g., liquid crystal display (LCD), cathode ray tube (CRT), etc.). The storage device 204 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 102 could be a networked computer system, a personal computer, a server, a smart phone, tablet computer etc. It is noted that the server 202 need not be a networked server, and indeed, could be a stand-alone computer system.

The functionality provided by the present disclosure could be provided by machine learning software code 206, which could be embodied as computer-readable program code stored on the storage device 204 and executed by the CPU 212 using any suitable, high or low level computing language, such as Python, Java, C, C++, C#, .NET, MATLAB, etc. The network interface 208 could include an Ethernet network interface device, a wireless network interface device, or any other suitable device which permits the server 202 to communicate via the network. The CPU 212 could include any suitable single-core or multiple-core microprocessor of any suitable architecture that is capable of implementing and running the machine learning software code 206 (e.g., Intel processor). The random access memory 214 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed:

1. A system for modeling a contribution of at least one factor to well performance comprising:
a memory; and
a processor in communication with the memory, the processor:
assembling a dataset including a first response variable received from the memory and at least one predictor of a well,
coupling the assembled dataset and geospatial data based on a location of the well,
generating a first predictive model based on all or a subset of non-geospatial data,
determining a second response variable based on a ratio of the first response variable to a first predictive value determined from the generated first predictive model,
generating a second predictive model for the determined second response variable based on all or a subset of the geospatial data, and
determining a second predictive value for the determined second response variable based on the second predictive model, the second predictive value being a productivity multiplier indicative of well performance.

2. The system of claim 1, wherein the well is a gas well or an oil well.

3. The system of claim 1, wherein the at least one factor is indicative of one or more of a completion factor or a geological factor, the completion factor being at least one of an amount of proppant, an amount of fracking fluid, a spacing between one or more wells, a maximum treatment rate and a maximum treatment PSI and the geological factor being at least one of well formation depth, a total organic carbon, source rock brittleness, an amount of ground water saturation, a volume of clay, a well thickness, and a net Nutech Permeability.

4. The system of claim 1, wherein the first response variable is an output and the predictor is input data mapped to the first response variable based on an empirical relationship.

5. The system of claim 1, wherein the first response variable is binary in a classifying process and the first response variable is continuous in a regression process.

6. The system of claim 1, wherein the geospatial data is determined from interpolation and distance calculations based on a specified geospatial location to a location of the geospatial data, and the geospatial data includes at least one of a geospatial predictor comprising at least one of a geological formation, a vertical depth below sea level of a formation of interest and at least one characteristic of a lithology of the formation of interest.

7. The system of claim 1, wherein the non-geospatial data relates to well information that is not specific to a location of the well and comprises at least one of a length of the well, engineering parameters of the well, and owner information of the well.

8. The system of claim 1, wherein the processor determines the productivity multiplier based on subsurface characteristics comprising at least one of source rock brittleness, formation depth or a net stock tank oil initially in place value.

9. The system of claim 1, wherein the processor further
determines an intensity value of the well, the intensity value being indicative of well performance in relation to an amount of proppant utilized and an amount of fracking fluid utilized, and
evaluates well performance based on a comparison of the productivity multiplier and the determined intensity value.

10. The system of claim 1, wherein the process further
determines an intensity value of the well, the intensity value being indicative of well performance in relation to an amount of proppant utilized and an amount of fracking fluid utilized,
determines an F score value based on one or more of a completion factor, a geological factor, time, and an operator, the F score value being indicative of variability in well performance, and
evaluates well performance based on a comparison of the productivity multiplier, the determined intensity value and the determined F score value.

11. The system of claim 10, wherein the completion factor is at least one of a spacing between one or more wells, a maximum treatment rate and a maximum treatment PSI and the geological factor is at least one of well formation depth, a total organic carbon, source rock brittleness, an amount of ground water saturation, a volume of clay, well thickness, and an average Nutech Permeability.

12. A method for modeling a contribution of at least one factor to well performance comprising the steps of:
assembling a dataset including a first response variable and at least one predictor of the well,
coupling the assembled dataset and geospatial data based on a location of the well,
generating a first predictive model based on all or a subset of non-geospatial data,
determining a second response variable based on a ratio of the first response variable to a first predictive value determined from the generated first predictive model,
generating a second predictive model for the determined second response variable based on all or a subset of the geospatial data, and
determining a second predictive value for the determined second response variable based on the second predictive model, the second predictive value being a productivity multiplier indicative of well performance.

13. The method of claim 12, further comprising:
determining the productivity multiplier based on subsurface characteristics comprising at least one of source rock brittleness, formation depth or a net stock tank oil initially in place value.

14. The method of claim 12, further comprising:
determining an intensity value of the well, the intensity value being indicative of well performance in relation to an amount of proppant utilized and an amount of fracking fluid utilized, and
evaluating well performance based on a comparison of the productivity multiplier and the determined intensity value.

15. The method of claim 12, further comprising:
determining an intensity value of the well, the intensity value being indicative of well performance in relation to an amount of proppant utilized and an amount of fracking fluid utilized,
determining an F score value based on one or more of a completion factor, a geological factor, time, and an operator, the F score value being indicative of variability in well performance, and
evaluating well performance based on a comparison of the productivity multiplier, the determined intensity value and the determined F score value,
wherein the completion factor is at least one of a spacing between one or more wells, a maximum treatment rate and a maximum treatment PSI and the geological factor is at least one of well formation depth, a total organic carbon, source rock brittleness, an amount of ground water saturation, a volume of clay, well thickness, and an average Nutech Permeability.

16. A non-transitory computer readable medium having instructions stored thereon for modeling a contribution of at least one factor to well performance which, when executed by a processor, causes the processor to carry out the steps of:
assembling a dataset including a first response variable and at least one predictor of the well,
coupling the assembled dataset and geospatial data based on a location of the well,
generating a first predictive model based on all or a subset of non-geospatial data,
determining a second response variable based on a ratio of the first response variable to a first predictive value determined from the generated first predictive model,
generating a second predictive model for the determined second response variable based on all or a subset of the geospatial data, and
determining a second predictive value for the second response variable based on the second predictive model, the second predictive value being a productivity multiplier indicative of well performance.

17. The non-transitory computer readable medium of claim 16, the processor further carrying out the steps of:
determining the productivity multiplier based on subsurface characteristics comprising at least one of source rock brittleness, formation depth or a net stock tank oil initially in place value.

18. The non-transitory computer readable medium of claim 16, the processor further carrying out the steps of:
determining an intensity value of the well, the intensity value being indicative of well performance in relation to an amount of proppant utilized and an amount of fracking fluid utilized, and
evaluating well performance based on a comparison of the productivity multiplier and the determined intensity value.

19. The non-transitory computer readable medium of claim 16, the processor further carrying out the steps of:
determining an intensity value of the well, the intensity value being indicative of well performance in relation to an amount of proppant utilized and an amount of fracking fluid utilized,
determining an F score value based on one or more of a completion factor, a geological factor, time, and an operator, the F score value being indicative of variability in well performance, and
evaluating well performance based on a comparison of the productivity multiplier, the determined intensity value and the determined F score value,
wherein the completion factor is at least one of a spacing between one or more wells, a maximum treatment rate and a maximum treatment PSI and the geological factor is at least one of well formation depth, a total organic carbon, source rock brittleness, an amount of ground water saturation, a volume of clay, well thickness, and an average Nutech Permeability.
